(19) United States
(12) Patent Application Publication
(10) Pub. No.: US 2008/0104911 A1
(43) Pub. Date: May 8, 2008

(54) Insulated concrete form

(76) Inventors: Shawn P. Jarvie, Monaca, PA (US); Michael T. Williams, Beaver Falls, PA (US); Justin D. Rubb, Coraopolis, PA (US); Ginawati Au, Aliquippa, PA (US); John K. Madish, Negley, OH (US); Blain Hileman, New Castle, PA (US)

Correspondence Address: NOVA Chemicals Inc., Westpointe Center, 1550 Coraopolis Heights Road, Moon Township, PA, 15108, US

(21) Appl. No.: 11/594,269

(22) Filed: Nov. 8, 2006

(51) Int. Cl. E04B 2/86; E04C 1/40; E04C 2/10; B28B 7/34

(52) U.S. Cl. 52/309.1; 52/426; 52/439; 52/436; 249/33; 52/576

(57) ABSTRACT

A concrete wall forming system of mold units that include first and second panel members and a plurality of connecting members. The panel members each have a horizontal length of three to thirty feet and a vertical height of three to twenty feet. The inner sides of the panels include slots extending vertically therethrough. The connecting members are detachable and securable with respect to the panels and extend the length vertically therebetween to maintain a spatial distance for defining a molding chamber. The connecting members include flanges detachably and securably extending within the slots in the panels. A mid-section portion in the connecting members contains a plurality of pour holes spaced along its length vertically. Concrete can be poured into the molding chamber and through the pour holes and once allowed to set and harden forms an insulated concrete wall.

### BACKGROUND OF THE INVENTION

1. Field of the Invention

The present invention is directed to a concrete wall forming system and insulated concrete walls formed using the wall forming system.

2. Description of the Prior Art

Concrete walls in building construction are most often produced by first setting up two parallel form walls and pouring concrete into the space between the forms. After the concrete hardens, the builder then removes the forms, leaving the cured concrete wall.

This prior art technique has drawbacks. Formation of the concrete walls is inefficient because of the time required to erect the forms, wait until the concrete cures, and take down the forms. This prior art technique, therefore, is an expensive, labor-intensive process.

Accordingly, techniques have developed for forming modular concrete walls, which use a foam insulating material. The modular form walls are set up parallel to each other and connecting components hold the two form walls in place relative to each other while concrete is poured there between. The form walls, however, remain in place after the concrete cures. That is, the form walls, which are constructed of foam insulating material, are a permanent part of the building after the concrete cures. The concrete walls made using this technique can be stacked on top of each other many stories high to form all of a building's walls. In addition to the efficiency gained by retaining the form walls as part of the permanent structure, the materials of the form walls often provide adequate insulation for the building.

Although the prior art includes many proposed variations to achieve improvements with this technique, drawbacks still exist for each design. The connecting components used in the prior art to hold the walls are constructed of (1) plastic foam, (2) high density plastic, or (3) a metal bridge, which is a non-structural support, i.e., once the concrete cures, the connecting components serve no function. Even so, these members provide thermal and sound insulation functions and have long been accepted by the building industry.

Thus, current insulated concrete form technology requires the use of small molded foam blocks normally 12 to 24 inches in height with a standard length of four feet. The large amount of horizontal and vertical joints that require bracing to correctly position the blocks during a concrete pour, restricts their use to shorter wall lengths and lower wall heights. Wall penetrations such as windows and doors require skillfully prepared and engineered forming to withstand the pressures exerted upon them during concrete placement. Plaster finishing crews have difficulty hanging drywall on such systems due to the problem of locating molded in furring strips. The metal or plastic furring strips in current designs are non-continuous in nature and are normally embedded within the foam faces. The characteristics present in current block forming systems require skilled labor, long lay-out times, engineered blocking and shoring and non-traditional finishing skills. This results in a more expensive wall that is not suitable for larger wall construction applications. The highly skilled labor force that is required to place, block, shore and apply finishes in a block system seriously restricts the use of such systems when compared to traditional concrete construction techniques.

One approach to solving the problem of straight and true walls on larger layouts has been to design larger blocks. Current existing manufacturing technology has limited this increase to 24 inches in height and eight feet in length. Other systems create hot wire cut opposing foamed plastic panels mechanically linked together in a secondary operation utilizing metal or plastic connectors. These panels are normally 48 inches in width and 8 feet in height and do not contain continuous furring strips.

However, none of the approaches described above adequately address the problems of form blowout at higher wall heights due to pressure exerted by the poured concrete, fast and easy construction with an unskilled labor force, and ease of finishing the walls with readily ascertainable attachment points.

Thus there is a need in the art for composite pre-formed building panels and insulated concrete forms with internal blocking and bracing elements that overcome the above-described problems.

### SUMMARY OF THE INVENTION

The present invention provides a concrete wall forming system that includes a plurality of mold units for forming a wall by receiving concrete therein. The mold units include a first panel member, a second panel member, and at least two connecting members.

The first panel member and the second panel member each have a horizontal length of from about three feet to about thirty feet and a vertical height of from about three feet to about twenty feet.

The first panel member includes (1) a first outer panel side including a first wall surface area extending generally vertically thereon; (2) a first inner panel side positioned oppositely from said first outer panel side; and (3) at least two first slots in the first inner panel side extending vertically therethrough.

The second panel member includes (1) a second outer panel side including a second wall surface area extending generally vertically thereon and facing oppositely from said first panel member; (2) a second inner panel side positioned oppositely from said second outer panel side and facing said first inner panel side of said first panel member; and (3) at least two second slots in the second inner panel side extending vertically therethrough.

The connecting members are detachable and securable with respect to the first panel member and the second panel member and extend the length vertically therebetween to maintain a spatial distance therebetween for defining a molding chamber therebetween. The connecting members include (1) a first flange detachably and securably extending within the first slot of the first panel member; (2) a second flange detachably and securably extending within the second slot of the second panel member; and (3) a mid-section portion containing a plurality of pour holes spaced along its length vertically.

### DESCRIPTION OF THE DRAWINGS

FIG. 1 is a perspective view of a mold unit according to the present invention;

FIG. 2 is an end elevation view of a mold unit according to the invention;

FIG. 3 is a top plan view of a mold unit according to the invention;

FIG. 4 is a front elevation view of a connecting member according to the invention;

FIG. 5 is a top plan view of a connecting member according to the invention; and

FIG. 6 is a cut away perspective view of an insulated reinforced concrete wall according to the invention.

### DETAILED DESCRIPTION OF THE INVENTION

For the purpose of the description hereinafter, the terms “upper”, “lower”, “inner”, “outer”, “right”, “left”, “vertical”, “horizontal”, “top”, “bottom”, and derivatives thereof, shall relate to the invention as oriented in the drawing Figures. However, it is to be understood that the invention may assume alternate variations and step sequences except where expressly specified to the contrary. It is also to be understood that the specific devices and processes, illustrated in the attached drawings and described in the following specification, is an exemplary embodiment of the present invention. Hence, specific dimensions and other physical characteristics related to the embodiment disclosed herein are not to be considered as limiting the invention. In describing the embodiments of the present invention, reference will be made herein to the drawings in which like numerals refer to like features of the invention.

Other than where otherwise indicated, all numbers or expressions referring to quantities, distances, or measurements, etc. used in the specification and claims are to be understood as modified in all instances by the term “about”. Accordingly, unless indicated to the contrary, the numerical parameters set forth in the following specification and attached claims are approximations that can vary depending upon the desired properties, which the present invention desires to obtain. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective measurement methods.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

As used herein, the term “expandable polymer matrix” refers to a polymeric material in particulate or bead form that is impregnated with a blowing agent such that when the particulates and/or beads are placed in a mold and heat is applied thereto, evaporation of the blowing agent (as described below) effects the formation of a cellular structure and/or an expanding cellular structure in the particulates and/or beads and the outer surfaces of the particulates and/or beads fuse together to form a continuous mass of polymeric material conforming to the shape of the mold.

As used herein, the term “polymer” is meant to encompass, without limitation, homopolymers, copolymers and graft copolymers.

As used herein, the terms “(meth)acrylic” and “(meth)acrylate” are meant to include both acrylic and methacrylic acid derivatives, such as the corresponding alkyl esters often referred to as acrylates and (meth)acrylates, which the term “(meth)acrylate” is meant to encompass.

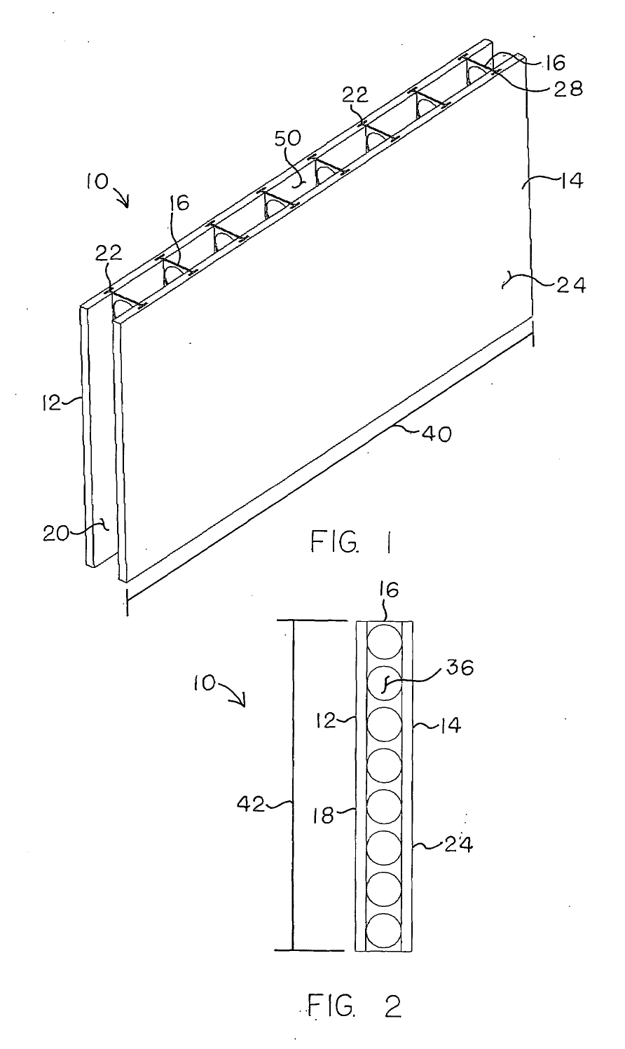

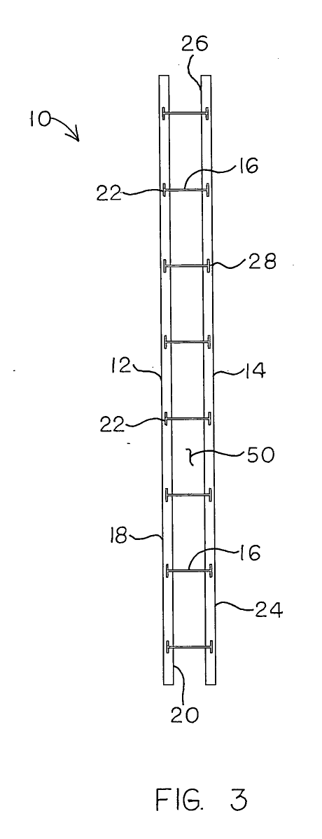

As shown in FIGS. 1-3, the present invention provides a concrete wall forming system that includes a plurality of mold units 10 for forming a wall by receiving concrete therein. Mold units 10 include first panel member 12, second panel member 14 and connecting members 16.

First panel member 12 includes first outer panel side 18 including a first wall surface area extending generally vertically thereon; first inner panel side 20 positioned oppositely from said first outer panel side; and a plurality of first slots 22 in first inner panel side 20 extending vertically therethrough.

Second panel member 14 includes second outer panel side 24 including second wall surface area extending generally vertically thereon and facing oppositely from first panel member 12. Second inner panel side 26 is positioned oppositely from second outer panel side 24 and facing first inner panel side 20 of first panel member 12. A plurality of second slots 28 in second inner panel side 26 extend vertically therethrough.

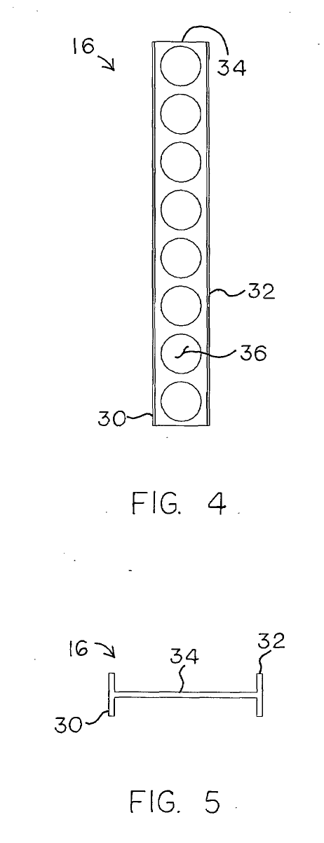

Connecting members 16 are detachable and securable with respect to first panel member 12 and said second panel member 16 and extend the length vertically there-between to maintain a spatial distance therebetween for defining a molding chamber therebetween. As shown in FIGS. 4 and 5, connecting members 16 include first flange 30, second flange 32, and mid-section portion 34. Referring now to FIGS. 1-5, when the present mold unit is assembled, first flanges 30 detachably and securably extend within first slots 22 of first panel member 12. Also, second flanges 32 detachably and securably extend within second slot 28 of second panel member 14. Mid-section portion 34 includes a plurality of pour holes 36 spaced along its length vertically.

In embodiments of the invention, mold units 10 can be assembled by placing panels 12 and 14 parallel to each other and sliding flanges 30 and 32 of connecting members 16 into slots 22 and 28 respectively.

In embodiments of the invention, first slot 22 and second slot 28 can have a T-shaped cross-sectional shape.

In embodiments of the invention, connecting members 16 can be made of metal, construction grade plastics, composite materials, ceramics, and the like.

Suitable construction grade plastics include, but are not limited to reinforced thermoplastics, thermoset resins, and reinforced thermoset resins. Thermo-plastics include polymers and polymer foams made up of materials that can be repeatedly softened by heating and hardened again on cooling. Suitable thermoplastic polymers include, but are not limited to homopolymers and copolymers of styrene, homopolymers and copolymers of C₂ to C₂₀ olefins, C₄ to C₂₀ dienes, polyesters, polyamides, homopolymers and copolymers of C₂ to C₂₀ (meth)acrylate esters, polyetherimides, polycarbonates, polyphenylethers, polyvinylchlorides, polyurethanes, and combinations thereof.

Suitable thermoset resins are resins that when heated to their cure point, undergo a chemical cross-linking reaction causing them to solidify and hold their shape rigidly, even at elevated temperatures. Suitable thermoset resins include, but are not limited to alkyd resins, epoxy resins, diallyl phthalate resins, melamine resins, phenolic resins, polyester resins, urethane resins, and urea, which can be crosslinked by reaction, as non-limiting examples, with diols, triols, polyols, and/or formaldehyde.

Reinforcing materials and/or fillers that can be incorporated into the thermoplastics and/or thermoset resins include, but are not limited to carbon fibers, aramid fibers, glass fibers, metal fibers, woven fabric or structures of the mentioned fibers, fiberglass, carbon black, graphite, clays, calcium carbonate, titanium dioxide, woven fabric or structures of the above-referenced fibers, and combinations thereof.

A non-limiting example of construction grade plastics are thermosetting polyester or vinyl ester resin systems reinforced with fiberglass that meet the requirements of required test methods known in the art, non-limiting examples being ASTM D790, ASTM D695, ASTM D3039 and ASTM D638.

The thermoplastics and thermoset resins can optionally include other additives, as a non-limiting example ultraviolet (UV) stabilizers, heat stabilizers, flame retardants, structural enhancements, biocides, and combinations thereof.

Suitable metals include, but are not limited to, aluminum, steel, stainless steel, tungsten, molybdenum, iron and alloys and combinations of such metals. In a particular embodiment of the invention, the metal bars, studs, joists and/or members are made of a light gauge metal.

In many embodiments of the invention, pour holes 36 have a shape selected from round, oval, elliptical, square, rectangular, triangular, hexagonal and octagonal. Further, the cross-sectional area of pour holes 36 can be at least about 4 in² (26 cm²), in some cases at least about 6 in² (39 cm²), and in other cases at least about 9 in² (58 cm²) and can be up to about 36 in² (232 cm²), in some cases up to 25 in² (161 cm²), and in other cases up to about 20 in² (129 cm²). The cross-sectional area of pour holes 36 can be any of the values or range between any of the values recited above.

In the present invention, first panel member 12 and second panel member 14 can have a horizontal length 40 of at least about three feet (0.9 m), in some cases at least about four feet (1.2 m) and in other cases at least about five feet (1.5 m) and length 40 can be up to about thirty feet (9.1 m), in some cases up to about twenty five feet (1.6 m) and in other cases up to about twenty feet (6.1 m). The length 40 of first panel member 12 and second panel member 14 can be any of the values or range between any of the values recited above.

In the present invention, first panel member 12 and second panel member 14 can have a vertical length 42 of at least about three feet (0.9 m), in some cases at least about four feet (1.2 m) and in other cases at least about five feet (1.5 m) and length 42 can be up to about twenty feet (6.1 m), in some cases up to about fifteen five feet (4.6 m) and in other cases up to about ten feet (3 m). The length 42 of first panel member 12 and second panel member 14 can be any of the values or range between any of the values recited above.

Mold units 10 can have a width, measured from first outer panel side 18 to second outer panel side 24 of from about 4, in some cases at least about 5, in other cases at least about 6 inches and can be up to about 30, in some cases up to about 24, and in other cases up to about 16 inches. The width is determined by the design for an overall insulated concrete wall. The width can be any value or range between any of the values recited above.

Typically, in the present concrete wall forming system, the first panel member and second panel member are made of an expanded polymer matrix. The expanded polymer matrix is typically molded from expandable thermoplastic particles. These expandable thermoplastic particles are made from any suitable thermoplastic homopolymer or copolymer. Particularly suitable for use are homopolymers derived from vinyl aromatic monomers including styrene, isopropylstyrene, alpha-methyl-styrene, nuclear methylstyrenes, chlorostyrene, tert-butylstyrene, and the like, as well as copolymers prepared by the copolymerization of at least one vinyl aromatic monomer as described above with one or more other monomers, non-limiting examples being divinyl-benzene, conjugated dienes (non-limiting examples being butadiene, isoprene, 1,3- and 2,4-hexadiene), alkyl methacrylates, alkyl acrylates, acrylonitrile, and maleic anhydride, wherein the vinyl aromatic monomer is present in at least 50% by weight of the copolymer. In an embodiment of the invention, styrenic polymers are used, particularly polystyrene. However, other suitable polymers can be used, such as polyolefins (e.g. poly-ethylene, polypropylene), polycarbonates, polyphenylene oxides, and mixtures thereof.

In embodiments of the invention, the expandable thermoplastic particles are made by polymerizing a monomer mixture that contains at least 50% by weight of one or more vinyl aromatic monomers. In particular embodiments, divinyl aromatic monomers can be present in the monomer mixture at a level of from at least about 0.01, in some cases at least about 0.02 wt. % and can be present at a level of up to about 0.07, in some cases up to about 0.06, and in other cases up to about 0.05 wt. % based on the weight of the monomer mixture. When the amount of divinyl aromatic monomers is too low, the physical property improvements described below may not be realized. When the amount of divinyl aromatic monomers is too high, the resulting polymer may be difficult or impossible to handle as desired. The amount of divinyl aromatic monomers present in the monomer mixture can be any value or range between any of the values recited above.

The vinyl aromatic monomers can be selected from styrene, isopropylstyrene, alpha-methylstyrene, nuclear methylstyrenes, chlorostyrene, tert-butylstyrene, vinyl toluene, vinyl xylene, ethyl vinyl benzene, vinyl naphthalene, para-methyl styrene, dibromostyrene and combinations thereof.

The divinyl aromatic monomers can be selected from divinyl benzene, divinyl naphthalene, trivinyl benzene, divinyl toluene, divinyl xylene, divinyl alkyl benzenes, divinyl phenanthrene, divinyl biphenyl, divinyl diphenyl methane, divinyl benzyl, divinyl phenyl ether, divinyl diphenyl sulfide; divinyl furan; and combinations thereof. The use of divinyl aromatic monomers is discussed in copending U.S. patent application Ser. No. 11/---,--- entitled “Foamed Plastic Structures,” the relevant disclosure of which is herein incorporated by reference.

During the pouring of concrete a hydraulic concrete load acts on the sidewalls of the mold units. This load can cause the sidewalls to deform from their proper vertical, lateral and longitudinal spatial relationships. Also during mold unit transport to a job site, the sidewalls have been known to deform due to the weight of other mold units thereon. The superior physical properties of the present structures, especially when divinyl aromatic monomers are included in the monomer mixture, act to minimize such deformations, a significant improvement over the prior art. Accordingly, problems that have existed when attempting to longitudinally and vertically connect the mold units, such as mating lap joint surfaces and/or tongue/groove elements not being properly aligned are minimized when this exemplary embodiment is employed.

The monomer mixture can be polymerized in any conventional manner. Generally the monomer mixture can be polymerized using a thermal and/or free radical initiation. The process can be a bulk polymerization in which the monomer mixture and, optionally, a minor amount of a diluent such as ethyl benzene, forms the reaction medium. Alternatively, the process can be a suspension or emulsion process in which the monomer mixture is suspended or dispersed in a different, non-hydrocarbon, typically aqueous phase and the polymerization takes place in the dispersed monomer droplets (e.g. suspension) or in a micelle into which monomer diffuses from the monomer droplets (e.g. emulsion).

According to one aspect of the present invention in which the polymer is prepared in a suspension or emulsion, the monomer mixture is suspended in water, from about 50 to 500 parts (in some cases about 75 to 250 parts) by weight, per 100 parts by weight of the monomer mixture using an effective amount of one or more suitable suspending agents. Any of the suspending agents useful in the suspension polymerization of vinyl aromatic polymers can be used. Non-limiting examples of suitable suspending agents include finely divided water-insoluble inorganic substances such as tricalcium phosphate and the like as well as water-soluble polymers such as polyvinyl alcohol, alkyl aryl sulfonates, hydroxyethyl cellulose, polyacrylic acid, methyl cellulose, polyvinyl pyrrolidone, and low molecular weight (often Mw less than about 5,000) polyalkylene glycols (e.g. polyethylene glycols and polypropylene glycols) and the like. Auxiliary suspending agents such as sodium linear alkylbenzene sulfonates canalso be employed. The use of tricalcium phosphate together with a sodium linear alkylbenzene sulfonate is particularly useful. The amount of the suspending agent necessary will vary depending on a number of factors but will generally be from about 0.01 to 1 part by weight per 100 parts by weight of the monomer mixture. One or more surfactants such as a polyoxyalkylene derivative of sorbitan monolaurate or other fatty acid ester, an ethylene oxide/propylene oxide block copolymer, or other non-ionic or anionic surface active agent can be added to the aqueous suspension if desired. In embodiments of the invention, the amount of surfactant is from about 0.01 to 1 part by weight per 100 parts by weight of monomer.

In addition to the monomers, the aqueous suspension can include a free radical initiator or free radical initiator system. The free radical generator can be a peroxide such as hydrogen peroxide or benzoyl peroxide, or a persulfate initiator.

The reaction mixture is heated to initiate polymerization, either thermally or by a free radical catalyst. After the monomers are polymerized to form particles or beads (generally resulting from the suspension process) or microparticles (generally resulting from the emulsion process), they can be separated from the aqueous phase and washed.

In a particular embodiment of the invention, the expandable thermoplastic particles are expandable polystyrene (EPS) particles. These particles can be in the form of beads, granules, or other particles convenient for the expansion and molding operations. Particles polymerized in an aqueous suspension process are essentially spherical and are useful for molding the mold units and/or forms described herein below. These particles can be screened so that their size ranges from about 0.008 inches (0.2 mm) to about 0.16 inches (4 mm).

In an embodiment of the invention, resin beads (unexpanded) containing any of the polymers or polymer compositions described herein have a particle size of at least 0.2 mm, in some situations at least 0.33 mm, in some cases at least 0.35 mm, in other cases at least 0.4 mm, in some instances at least 0.45 mm and in other instances at least 0.5 mm. Also, the resin beads can have a particle size of up to about 4 mm, in some situations up to about 3.5 mm, in other situations up to about 3 mm, in some instances up to 2 mm, in other instances up to 2.5 mm, in some cases up to 2.25 mm, in other cases up to 2 mm, in some situations up to 1.5 mm and in other situations up to 1 mm. The resin beads used in this embodiment can be any value or can range between any of the values recited above.

The average particle size and size distribution of the expandable resin beads or pre-expanded resin beads can be determined using low angle light scattering, which can provide a weight average value. As a non-limiting example, a Model LA-910 Laser Diffraction Particle Size Analyzer available from Horiba Ltd., Kyoto, Japan can be used

As used herein, the terms “expandable thermoplastic particles” or “expandable resin beads” refers to a polymeric material in particulate or bead form that is impregnated with a blowing agent such that when the particulates and/or beads are placed in a mold or expansion device and heat is applied thereto, evaporation of the blowing agent (as described below) effects the formation of a cellular structure and/or an expanding cellular structure in the particulates and/or beads. When expanded in a mold, the outer surfaces of the particulates and/or beads fuse together to form a continuous mass of polymeric material conforming to the shape of the mold.

As used herein, the terms “pre-expanded thermo-plastic particles”, “pre-expanded resin beads”, or “prepuff” refers to expandable resin beads that have been expanded, but not to their maximum expansion factor and whose outer surfaces have not fused. As used herein, the term “expansion factor” refers to the volume a given weight of resin bead occupies, typically expressed as cc/g. Pre-expanded resin beads can be further expanded in a mold where the outer surfaces of the pre-expanded resin beads fuse together to form a continuous mass of polymeric material conforming to the shape of the mold.

The expandable thermoplastic particles can be impregnated using any conventional method with a suitable blowing agent. As a non-limiting example, the impregnation can be achieved by adding the blowing agent to the aqueous suspension during the polymerization of the polymer, or alternatively by re-suspending the polymer particles in an aqueous medium and then incorporating the blowing agent as taught in U.S. Pat. No. 2,983,692. Any gaseous material or material which will produce gases on heating can be used as the blowing agent. Conventional blowing agents include aliphatic hydrocarbons containing 4 to 6 carbon atoms in the molecule, such as butanes, pentanes, hexanes, and the halogenated hydrocarbons, e.g. CFC's and HCFC'S, which boil at a temperature below the softening point of the polymer chosen. Mixtures of these aliphatic hydrocarbon blowing agents can also be used.

Alternatively, water can be blended with these aliphatic hydrocarbons blowing agents or water can be used as the sole blowing agent as taught in U.S. Pat. Nos. 6,127,439; 6,160,027; and 6,242,540 in these patents, water-retaining agents are used. The weight percentage of water for use as the blowing agent can range from 1 to 20%. The texts of U.S. Pat. Nos. 6,127,439, 6,160,027 and 6,242,540 are incorporated herein by reference.

The impregnated thermoplastic particles are generally pre-expanded to a density of at least 0.5 lb/ft³, in some cases at least 0.75 lb/ft³, in other cases at least 1.0 lb/ft³, in some situations at least 1.25 lb/ft³, in other situations at least 1.5 lb/ft³, and in some instances at least about 1.75 lb/ft³. Also, the density of the impregnated pre-expanded particles can be up to 12 lb/ft³, in some cases up to 10 lb/ft³, and in other cases up to 5 lb/ft³. When the density is too low, the panels may deform when concrete is poured into the mold units. When the density is too high, the economics of using the present mold units may become unfavorable. The density of the impregnated pre-expanded particles, as well as the density of the first panel member and the second panel member, can be any value or range between any of the values recited above. The pre-expansion step is conventionally carried out by heating the impregnated beads via any conventional heating medium, such as steam, hot air, hot water, or radiant heat. One generally accepted method for accomplishing the pre-expansion of impregnated thermoplastic particles is taught in U.S. Pat. No. 3,023,175.

The impregnated thermoplastic particles can be foamed cellular polymer particles as taught in U.S. Patent Application Publication No. 2002/0117769, the teachings of which are incorporated herein by reference. The foamed cellular particles can be polystyrene that are pre-expanded and contain a volatile blowing agent at a level of less than 14 wt %, in some situations less than 8 wt %, in some cases ranging from about 2 wt % to about 7 wt %, and in other cases ranging from about 2.5 wt % to about 6.5 wt % based on the weight of the polymer.

The thermoplastic particles according to the invention can include an interpolymer of a polyolefin and in situ polymerized vinyl aromatic monomers. Non-limiting examples of such interpolymers are disclosed in U.S. Pat. Nos. 4,303,756, 4,303,757 and 6,908,949, the relevant portions of which are herein incorporated by reference. A non-limiting example of interpolymers that can be used in the present invention include those available under the trade name ARCEL®, available from NOVA Chemicals Inc., Pittsburgh, Pa. and PIOCELAN®, available from Sekisui Plastics Co., Ltd., Tokyo, Japan.

The expanded polymer matrix can include customary ingredients and additives, such as pigments, dyes, colorants, plasticizers, mold release agents, stabilizers, ultraviolet light absorbers, mold prevention agents, antioxidants, flame retardants and so on. Typical pigments include, without limitation, inorganic pigments such as carbon black, graphite, expandable graphite, zinc oxide, titanium dioxide, and iron oxide, as well as organic pigments such as quinacridone reds and violets and copper phthalocyanine blues and greens.

In a particular embodiment of the invention the pigment is carbon black, a non-limiting example of such a material being EPS SILVER®, available from NOVA Chemicals Inc.

In another particular embodiment of the invention the pigment is graphite, a non-limiting example of such a material being NEOPOR®, available from BASF Aktiengesellschaft Corp., Ludwigshafen am Rhein, Germany.

Non-limiting examples of suitable flame retardants that can be used in the invention include phosphoric esters, such as triphenyl phosphate; bromine compounds, such as decabromobiphenyl, pentabromotoluene, brominated epoxy resin, hexabromocyclododecane, penta-bromophenyl allyl ether, tris dibromo-propylphosphate, bis allyl ether of tetrabromo-bis-phenol A, octabromo-diphenyl oxide, decabromodiphenyl oxide, halogenated hydrocarbyl phosphate or phosphonate esters and trisdibromopropyl antimonite; chlorine compounds such as chloroparaffins, mixed halogen compounds such as pentabromo monochloro cyclohexane; nitrogen-containing phosphorus compounds such as melamine derivatives; alumina trihydrates hydroxylamine esters; antimony compounds such as antimony trioxide; boron compounds; and zinc compounds. When used, the flame retardants are present at from about 0.6 to about 7% by weight based on the weight of the expandable polymer matrix.

The pre-expanded particles or “pre-puff” are usually heated in a closed mold to form the present mold units. Slots 22 and 24 can be molded into panels 12 and 14 or in some embodiments slots 22 and 28 can be cut into panels 12 and 14 with, as non-limiting examples, a knife or a hot wire cutter.

In another embodiment of the invention, the mold units can have a male “tongue” edge and a female “groove” edge that facilitates a “tongue and groove” union of two matching mold units. In other embodiments of the invention, the mold units can have overlapping lip ends adapted to join matching mold units together. As another example, the first panel member and the second panel member can each have a male end that includes a tongue edge and a female end that includes a female groove edge that facilitates a tongue and groove union between corresponding members.

Thus, the present concrete wall forming system can include a plurality of mold units arranged sequentially to form the wall forming system.

In embodiments of the invention, a finish surface can be attached to one or more of first outer panel side 18 and/or second outer panel side 24. As non-limiting examples, the finish surface can be selected from wood, rigid plastics, wood paneling, concrete panels, cement panels, drywall, sheetrock, particle board, rigid plastic panels, a metal lath, and combinations thereof.

According to the present invention, an insulated concrete wall can be formed by pouring concrete into molding chamber 50, which is defined by inside surface 20 of panel 12 and inside surface 26 of panel 14. The concrete is then allowed to set and harden in the molding chamber.

Any suitable type of concrete can be used to make the concrete walls and concrete wall systems described herein. The specific type of concrete will depend on the desired and designed properties of the concrete walls and concrete wall systems. In embodiments of the invention, the concrete includes one or more hydraulic cement compositions selected from Portland cements, pozzolana cements, gypsum cements, aluminous cements, magnesia cements, silica cements, and slag cements.

In an embodiment of the invention, the concrete includes a hydraulic cement composition. The hydraulic cement composition can be present at a level of at least 3, in certain situations at least 5, in some cases at least 7.5, and in other cases at least 9 volume percent and can be present at levels up to 40, in some cases up to 35, in other cases up to 32.5, and in some instances up to 30 volume percent of the cement mixture. The concrete can include the hydraulic cement composition at any of the above-stated levels or at levels ranging between any of levels stated above.

In an embodiment of the invention, the concrete mixture can optionally include other aggregates and adjuvants known in the art including but not limited to sand, additional aggregate, plasticizers and/or fibers. Suitable fibers include, but are not limited to glass fibers, silicon carbide, aramid fibers, polyester, carbon fibers, composite fibers, fiberglass, metal and combinations thereof as well as fabric containing the above-mentioned fibers, and fabric containing combinations of the above-mentioned fibers.

Non-limiting examples of fibers that can be used in the invention include MeC-GRID® and C-GRID® available from TechFab, LLC, Anderson, SC, KEVLAR® available from E.I. du Pont de Nemours and Company, Wilmington, Del., TWARON® available from Teijin Twaron B.V., Arnheim, the Netherlands, SPECTRA® available from Honeywell International Inc., Morristown, N.J., DACRON® available from Invista North America S.A.R.L. Corp. Wilmington, Del., and VECTRAN® available from Hoechst Celanese Corp., New York, N.Y. The fibers can be used in a mesh structure, intertwined, interwoven, and oriented in any desirable direction.

In a particular embodiment of the invention fibers can make up at least 0.1, in some cases at least 0.5, in other cases at least 1, and in some instances at least 2 volume percent of the concrete composition. Further, fibers can provide up to 10, in some cases up to 8, in other cases up to 7, and in some instances up to 5 volume percent of the concrete composition. The amount of fibers is adjusted to provide desired properties to the concrete composition. The amount of fibers can be any value or range between any of the values recited above.

Further to this embodiment, the additional aggregate can include, but is not limited to, one or more materials selected from common aggregates such as sand, stone, and gravel. Common lightweight aggregates can include ground granulated blast furnace slag, fly ash, glass, silica, expanded slate and clay; insulating aggregates such as pumice, perlite, vermiculite, scoria, and diatomite; light-weight aggregate such as expanded shale, expanded slate, expanded clay, expanded slag, fumed silica, pelletized aggregate, extruded fly ash, tuff, and macrolite; and masonry aggregate such as expanded shale, clay, slate, expanded blast furnace slag, sintered fly ash, coal cinders, pumice, scoria, and pelletized aggregate.

When included, the other aggregates and adjuvants are present in the concrete mixture at a level of at least 0.5, in some cases at least 1, in other cases at least 2.5, in some instances at least 5 and in other instances at least 10 volume percent of the concrete mixture. Also, the other aggregates and adjuvants can be present at a level of up to 95, in some cases up to 90, in other cases up to 85, in some instances up to 65 and in other instances up to 60 volume percent of the concrete mixture. The other aggregates and adjuvants can be present in the concrete mixture at any of the levels indicated above or can range between any of the levels indicated above.

In embodiments of the invention, the concrete compositions can contain one or more additives, non-limiting examples of such being anti-foam agents, water-proofing agents, dispersing agents, set-accelerators, set-retarders, plasticizing agents, superplasticizing agents, freezing point decreasing agents, adhesiveness-improving agents, and colorants. The additives are typically present at less than one percent by weight with respect to total weight of the composition, but can be present at from 0.1 to 3 weight percent.

Suitable dispersing agents or plasticizers that can be used in the invention include, but are not limited to hexametaphosphate, tripolyphosphate, polynaphthalene sulphonate, sulphonated polyamine and combinations thereof.

Suitable plasticizing agents that can be used in the invention include, but are not limited to poly-hydroxycarboxylic acids or salts thereof, polycar-boxylates or salts thereof; lignosulfonates, poly-ethylene glycols, and combinations thereof.

Suitable superplasticizing agents that can be used in the invention include, but are not limited to alkaline or earth alkaline metal salts of lignin sulfonates; lignosulfonates, alkaline or earth alkaline metal salts of highly condensed naphthalene sulfonic acid/formaldehyde condensates; polynaphthalene sulfonates, alkaline or earth alkaline metal salts of one or more polycarboxylates (such as poly(meth)-acrylates and the polycarboxylate comb copolymers described in U.S. Pat. No. 6,800,129, the relevant portions of which are herein incorporated by reference); alkaline or earth alkaline metal salts of melamine/formaldehyde/sulfite condensates; sulfonic acid esters; carbohydrate esters; and combinations thereof.

Suitable set-accelerators that can be used in the invention include, but are not limited to soluble chloride salts (such as calcium chloride), triethanol-amine, paraformaldehyde, soluble formate salts (such as calcium formate), sodium hydroxide, potassium hydroxide, sodium carbonate, sodium sulfate, 12CaO.7Al₂O₃, sodium sulfate, aluminum sulfate, iron sulfate, the alkali metal nitrate/sulfonated aromatic hydrocarbon aliphatic aldehyde condensates disclosed in U.S. Pat. No. 4,026,723, the water soluble surfactant accelerators disclosed in U.S. Pat. No. 4,298,394, the methylol derivatives of amino acids accelerators disclosed in U.S. Pat. No. 5,211,751, and the mixtures of thiocyanic acid salts, alkanolamines, and nitric acid salts disclosed in U.S. Pat. No. Re. 35,194, the relevant portions of which are herein incorporated by reference, and combinations thereof.

Suitable set-retarders that can be used in the invention include, but are not limited to lignosul-fonates, hydroxycarboxylic acids (such as gluconic acid, citric acid, tartaric acid, maleic acid, salicylic acid, glucoheptonic acid, arabonic acid, acid, and inorganic or organic salts thereof such as sodium, potassium, calcium, magnesium, ammonium and triethanolamine salt), cardonic acid, sugars, modified sugars, phosphates, borates, silico-fluorides, calcium bromate, calcium sulfate, sodium sulfate, monosac-charides such as glucose, fructose, galactose, saccharose, xylose, apiose, ribose and invert sugar, oligosaccharides such as disaccharides and trisaccharides, such oligosaccharides as dextrin, polysaccharides such as dextran, and other saccharides such as molasses containing these; sugar alcohols such as sorbitol; magnesium silicofluoride; phosphoric acid and salts thereof, or borate esters; aminocarboxylic acids and salts thereof; alkali-soluble proteins; humic acid; tannic acid; phenols; polyhydric alcohols such as glycerol; phosphonic acids and derivatives thereof, such as aminotri(methylenephosphonic acid), 1-hydroxyethylidene-1,1-diphosphonic acid, ethylenediaminetetra(methylenephosphonic acid), diethylenetriaminepenta(methylenephosphonic acid), and alkali metal or alkaline earth metal salts thereof, and combinations of the set-retarders indicated above.

Suitable defoaming agents that can be used in the invention include, but are not limited to silicone-based defoaming agents (such as dimethylpolysiloxane, diemthylsilicone oil, silicone paste, silicone emulsions, organic group-modified polysiloxanes (polyorganosiloxanes such as dimethylpolysiloxane), fluorosilicone oils, etc.), alkyl phosphates (such as tributyl phosphate, sodium octylphosphate, etc.), mineral oil-based defoaming agents (such as kerosene, liquid paraffin, etc.), fat- or oil-based defoaming agents (such as animal or vegetable oils, sesame oil, castor oil, alkylene oxide adducts derived there from, etc.), fatty acid-based defoaming agents (such as oleic acid, stearic acid, and alkylene oxide adducts derived there from, etc.), fatty acid ester-based defoaming agents (such as glycerol monoricinolate, alkenylsuccinic acid derivatives, sorbitol monolaurate, sorbitol trioleate, natural waxes, etc.), oxyalkylene type defoaming agents, alcohol-based defoaming agents: octyl alcohol, hexadecyl alcohol, acetylene alcohols, glycols, etc.), amide-based defoaming agents (such as acrylate polyamines, etc.), metal salt-based defoaming agents (such as aluminum stearate, calcium oleate, etc.) and combinations of the above-described defoaming agents.

Suitable freezing point decreasing agents that can be used in the invention include, but are not limited to ethyl alcohol, calcium chloride, potassium chloride, and combinations thereof.

Suitable adhesiveness-improving agents that can be used in the invention include, but are not limited to polyvinyl acetate, styrene-butadiene, homopolymers and copolymers of (meth)acrylate esters, and combinations thereof.

Suitable water-repellent or water-proofing agents that can be used in the invention include, but are not limited to fatty acids (such as stearic acid or oleic acid), lower alkyl fatty acid esters (such as butyl stearate), fatty acid salts (such as calcium or aluminum stearate), silicones, wax emulsions, hydrocarbon resins, bitumen, fats and oils, silicones, paraffins, asphalt, waxes, and combinations thereof. Although not used in many embodiments of the invention, when used suitable air-entraining agents include, but are not limited to vinsol resins, sodium abietate, fatty acids and salts thereof, tensides, alkyl-aryl-sulfonates, phenol ethoxylates, lignosulfonates, and mixtures thereof.

In some embodiments of the invention, the concrete is light-weight concrete. As used herein, the term “light weight concrete” refers to concrete where light-weight aggregate is included in a cementitous mixture. Exemplary light weight concrete compositions that can be used in the present invention are disclosed in U.S. Pat. Nos. 3,021,291, 3,214,393, 3,257,338, 3,272,765, 5,622,556, 5,725,652, 5,580,378, and 6,851,235, JP 9 071 449, WO 98 02 397, WO 00/61519, and WO 01/66485 the relevant portions of which are incorporated herein by reference.

In particular embodiments of the present invention, the lightweight concrete (LWC) composition includes a concrete mixture and polymer particles, a non-limiting example of which is disclosed in U.S. Patent Application Publication 2006/0225618 A1, the relevant disclosure of which is hereby incorporated by reference. In many instances the size, composition, structure, and physical properties of expanded polymer particles, and in some instances their resin bead precursors, can greatly affect the physical properties of LWC used in the invention. Of particular note is the relationship between bead size and expanded polymer particle density on the physical properties of the resulting LWC wall.

The polymer particles, which can optionally be expanded polymer particles, are present in the LWC composition at a level of at least 10, in some instances at least 15, in other instances at least 20, in particular situations up to 25, in some cases at least 30, and in other cases at least 35 volume percent and up to 90, in some cases up to 85, in other cases up to 78, in some instances up to 75, in other instance up to 65, in particular instances up to 60, in some cases up to 50, and in other cases up to 40 volume percent based on the total volume of the LWC composition. The amount of polymer particles will vary depending on the particular physical properties desired in a finished LWC wall. The amount of polymer particles in the LWC composition can be any value or can range between any of the values recited above.

The polymer particles can include any particles derived from any suitable expandable thermoplastic material. The actual polymer particles are selected based on the particular physical properties desired in a finished LWC wall. As a non-limiting example, the polymer particles, which can optionally be expanded polymer particles, can include one or more polymers selected from homopolymers of vinyl aromatic monomers; copolymers of at least one vinyl aromatic monomer with one or more of divinylbenzene, conjugated dienes, alkyl methacrylates, alkyl acrylates, acrylonitrile, and/or maleic anhydride; polyolefins; polycarbonates; polyesters; polyamides; natural rubbers; synthetic rubbers; and combinations thereof.

In an embodiment of the invention, the polymer particles include thermoplastic homopolymers or copolymers selected from homopolymers derived from vinyl aromatic monomers including styrene, isopropyl-styrene, alpha-methylstyrene, nuclear methylstyrenes, chlorostyrene, tert-butylstyrene, and the like, as well as copolymers prepared by the copolymerization of at least one vinyl aromatic monomer as described above with one or more other monomers, non-limiting examples being divinylbenzene, conjugated dienes (non-limiting examples being butadiene, isoprene, 1,3- and 2,4-hexadiene), alkyl methacrylates, alkyl acrylates, acrylonitrile, and maleic anhydride, wherein the vinyl aromatic monomer is present in at least 50% by weight of the copolymer. In an embodiment of the invention, styrenic polymers are used, particularly polystyrene. However, other suitable polymers can be used, such as polyolefins (e.g. polyethylene, polypropylene), polycarbonates, polyphenylene oxides, and mixtures thereof.

In a particular embodiment of the invention, the polymer particles are expandable polystyrene (EPS) particles. These particles can be in the form of beads, granules, or other particles.

In the present invention, particles polymerized in a suspension process, which are essentially spherical resin beads, are useful as polymer particles or for making expanded polymer particles. However, polymers derived from solution and bulk polymerization techniques that are extruded and cut into particle sized resin bead sections can also be used.

In an embodiment of the invention, resin beads (unexpanded) to be used in the lightweight concrete containing any of the polymers or polymer compositions described herein have a particle size of at least 0.2 mm, in some situations at least 0.33 mm, in some cases at least 0.35 mm, in other cases at least 0.4 mm, in some instances at least 0.45 mm and in other instances at least 0.5 mm. Also, the resin beads can have a particle size of up to 3 mm, in some instances up to 2 mm, in other instances up to 2.5 mm, in some cases up to 2.25 mm, in other cases up to 2 mm, in some situations up to 1.5 mm and in other situations up to 1 mm. In this embodiment, the physical properties of LWC walls made according to the invention have inconsistent or undesirable physical properties when resin beads having particle sizes outside of the above described ranges are used to make the expanded polymer particles. The resin beads used in this embodiment can be any value or can range between any of the values recited above.

The expandable thermoplastic particles or resin beads can optionally be impregnated using any conventional method with a suitable blowing agent. As a non-limiting example, the impregnation can be achieved by adding the blowing agent to the aqueous suspension during the polymerization of the polymer, or alternatively by re-suspending the polymer particles in an aqueous medium and then incorporating the blowing agent as taught in U.S. Pat. No. 2,983,692. Any gaseous material or material which will produce gases on heating can be used as the blowing agent. Conventional blowing agents include aliphatic hydrocarbons containing 4 to 6 carbon atoms in the molecule, such as butanes, pentanes, hexanes, and the halogenated hydrocarbons, e.g. CFC's and HCFC'S, which boil at a temperature below the softening point of the polymer chosen. Mixtures of these aliphatic hydrocarbon blowing agents can also be used.

Alternatively, water can be blended with these aliphatic hydrocarbons blowing agents or water can be used as the sole blowing agent as taught in U.S. Pat. Nos. 6,127,439; 6,160,027; and 6,242,540 in these patents, water-retaining agents are used. The weight percentage of water for use as the blowing agent can range from 1 to 20%. The texts of U.S. Pat. Nos. 6,127,439, 6,160,027 and 6,242,540 are incorporated herein by reference.

The impregnated polymer particles or resin beads used in the lightweight concrete are optionally expanded to a bulk density of at least 1.75 lb/ft³ (0.028 g/cc), in some circumstances at least 2 lb/ft³ (0.032 g/cc) in other circumstances at least 3 lb/ft³ (0.048 g/cc) and in particular circumstances at least 3.25 lb/ft³ (0.052 g/cc) or 3.5 lb/ft³ (0.056 g/cc). When non-expanded resin beads are used higher bulk density beads can be used. As such, the bulk density can be as high as 40 lb/ft³ (0.64 g/cc). In other situations, the polymer particles are at least partially expanded and the bulk density can be up to 35 lb/ft³ (0.56 g/cc), in some cases up to 30 lb/ft³ (0.48 g/cc), in other cases up to 25 lb/ft³ (0.4 g/cc), in some instances up to 20 lb/ft³ (0.32 g/cc), in other instances up to 15 lb/ft³ (0.24 g/cc) and in certain circumstances up to 10 lb/ft³ (0.16 g/cc). The bulk density of the polymer particles can be any value or range between any of the values recited above. The bulk density of the polymer particles, resin beads and/or prepuff particles is determined by weighing a known volume of polymer particles, beads and/or prepuff particles (aged 24 hours at ambient conditions).

The expansion step is conventionally carried out by heating the impregnated beads via any conventional heating medium, such as steam, hot air, hot water, or radiant heat. One generally accepted method for accomplishing the pre-expansion of impregnated thermoplastic particles is taught in U.S. Pat. No. 3,023,175.

The impregnated polymer particles can be foamed cellular polymer particles as taught in U.S. Patent Application Publication No. 2002/0117769, the teachings of which are incorporated herein by reference. The foamed cellular particles can be polystyrene that are expanded and contain a volatile blowing agent at a level of less than 14 wt %, in some situations less than 8 wt %, in some cases ranging from about 2 wt % to about 7 wt %, and in other cases ranging from about 2.5 wt % to about 6.5 wt % based on the weight of the polymer.

An interpolymer of a polyolefin and in situ polymerized vinyl aromatic monomers that can be included in the expanded thermoplastic resin or polymer particles according to the invention is disclosed in U.S. Pat. Nos. 4,303,756, 4,303,757 and 6,908,949, the relevant portions of which are herein incorporated by reference.

The polymer particles can include customary ingredients and additives, such as flame retardants, pigments, dyes, colorants, plasticizers, mold release agents, stabilizers, ultraviolet light absorbers, mold prevention agents, antioxidants, rodenticides, insect repellents, and so on. Typical pigments include, without limitation, inorganic pigments such as carbon black, graphite, expandable graphite, zinc oxide, titanium dioxide, and iron oxide, as well as organic pigments such as quinacridone reds and violets and copper phthalocyanine blues and greens.

In a particular embodiment of the invention the pigment is carbon black, a non-limiting example of such a material being EPS SILVER®, available from NOVA Chemicals Inc.

In another particular embodiment of the invention the pigment is graphite, a non-limiting example of such a material being NEOPOR®, available from BASF Aktiengesellschaft Corp., Ludwigshafen am Rhein, Germany.

When materials such as carbon black and/or graphite are included in the polymer particles, improved insulating properties, as exemplified by higher R values for materials containing carbon black or graphite (as determined using ASTM-C518), are provided. As such, the R value of the expanded polymer particles containing carbon black and/or graphite or materials made from such polymer particles are at least 5% higher than observed for particles or resulting walls that do not contain carbon black and/or graphite.

The expanded polymers used in the lightweight concrete can have an average particle size of at least 0.2, in some circumstances at least 0.3, in other circumstances at least 0.5, in some cases at least 0.75, in other cases at least 0.9 and in some instances at least 1 mm and can be up to 8, in some circumstances up to 6, in other circumstances up to 5, in some cases up to 4, in other cases up to 3, and in some instances up to 2.5 mm. When the size of the expanded polymer particles is too small or too large, the physical properties of LWC walls made using the present LWC composition can be undesirable. The average particle size of the expanded polymer particles can be any value and can range between any of the values recited above. The average particle size of the expanded polymer particles can be determined using laser diffraction techniques or by screening according to mesh size using mechanical separation methods well known in the art.

In an embodiment of the invention, the polymer particles or expanded polymer particles used in the mold unit panels or in the lightweight concrete can have a minimum average cell wall thickness, which helps to provide desirable physical properties to LWC walls made using the present LWC composition. The average cell wall thickness and inner cellular dimensions can be determined using scanning electron microscopy techniques known in the art. The expanded polymer particles can have an average cell wall thickness of at least 0.15 μm, in some cases at least 0.2 μm and in other cases at least 0.25 μm. Not wishing to be bound to any particular theory, it is believed that a desirable average cell wall thickness results when resin beads having the above-described dimensions are expanded to the above-described densities.

In an embodiment of the invention, the polymer beads are optionally expanded to form the expanded polymer particles such that a desirable cell wall thickness as described above is achieved. Though many variables can impact the wall thickness, it is desirable, in this embodiment, to limit the expansion of the polymer bead so as to achieve a desired wall thickness and resulting expanded polymer particle strength. Optimizing processing steps and blowing agents can expand the polymer beads to a minimum of 1.75 lb/ft³ (0.028 g/cc). This property of the expanded polymer bulk density, can be described by pcf (lb/ft³) or by an expansion factor (cc/g).

As used herein, the term “expansion factor” refers to the volume a given weight of expanded polymer bead occupies, typically expressed as cc/g.

In order to provide expanded polymer particles with desirable cell wall thickness and strength, the expanded polymer particles are not expanded to their maximum expansion factor; as such an extreme expansion yields particles with undesirably thin cell walls and insufficient strength. Further, the polymer beads can be expanded at least 5%, in some cases at least 10%, and in other cases at least 15% of their maximum expansion factor. However, so as not to cause the cell wall thickness to be too thin, the polymer beads are expanded up to 80%, in some cases up to 75%, in other cases up to 70%, in some instances up to 65%, in other instances up to 60%, in some circumstances up to 55%, and in other circumstances up to 50% of their maximum expansion factor. The polymer beads can be expanded to any degree indicated above or the expansion can range between any of the values recited above. Typically, the polymer beads or prepuff beads do not further expand when formulated into the present concrete compositions and do not further expand while the concrete compositions set, cure and/or harden.

The prepuff or expanded polymer particles typically have a cellular structure or honeycomb interior portion and a generally smooth continuous polymeric surface as an outer surface, i.e., a substantially continuous outer layer. The smooth continuous surface can be observed using scanning electron microscope (SEM) techniques at 1000× magnification. SEM observations do not indicate the presence of holes in the outer surface of the prepuff or expanded polymer particles. Cutting sections of the prepuff or expanded polymer particles and taking SEM observations reveals the generally honeycomb structure of the interior of the prepuff or expanded polymer particles.

The polymer particles or expanded polymer particles can have any cross-sectional shape that allows for providing desirable physical properties in LWC walls. In an embodiment of the invention, the expanded polymer particles have a circular, oval or elliptical cross-section shape. In embodiments of the invention, the prepuff or expanded polymer particles have an aspect ratio of 1, in some cases at least 1 and the aspect ratio can be up to 3, in some cases up to 2 and in other cases up to 1.5. The aspect ratio of the prepuff or expanded polymer particles can be any value or range between any of the values recited above.

In particular embodiments of the invention, the light-weight concrete includes from 10 to 90 volume percent of a cement composition, from 10 to 90 volume percent of particles having an average particle diameter of from 0.2 mm to 8 mm, a bulk density of from 0.028 g/cc to 0.64 g/cc, an aspect ratio of from 1 to 3, and from 10 to 50 volume percent of sand and/or other fine aggregate, where the sum of components used does not exceed 100 volume percent.

Light-weight concrete compositions that are particularly useful in the present invention include those disclosed in co-pending U.S. application Ser. No. 11/387,198, the relevant portions of the disclosure are incorporated herein by reference.

When light-weight concrete is used in conjunction with the present wall forming system, the density of the mold units can be decreased further or, even greater concrete pour heights can be used at the same mold unit density.

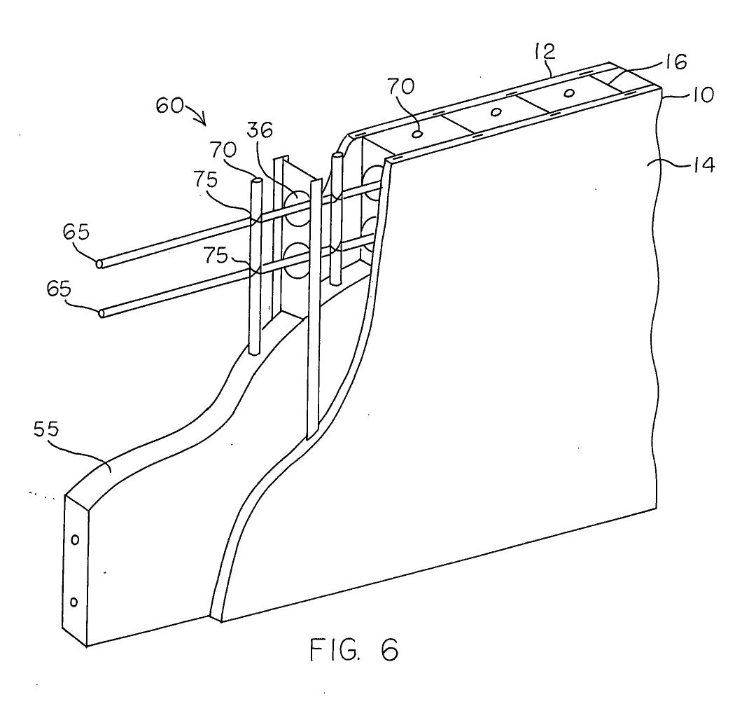

As shown in FIG. 6, when concrete is poured into mold unit 10 and allowed to set, concrete wall 55 is formed. Concrete wall 55 includes a solid mass of concrete in the shape of molding chamber 50 with connecting members 16 embedded therein as a result of the concrete flowing through pour holes 36 prior to it setting and hardening.

As those skilled in the art will appreciate, various numbers of courses of mold unit 10 can be used to provide a plurality of mold units and a higher and/or longer insulated concrete wall according to the invention. Also, various insulated concrete wall system layouts can be designed with one or more courses of mold units.

As such, the present invention provides a wall that includes one or more rows of the concrete wall forming systems as described above where concrete is poured into and set in mold chamber 50 in the mold units.

Embodiments of the invention provide a continuous wall that includes the above-described concrete wall forming system, where concrete is poured into and set in mold chamber 50 in mold units 10.

Often, in order to add strength to an insulated concrete wall system, concrete reinforcing products are placed within the mold chambers described above. Typically, the concrete reinforcing products are placed in molding chamber 50 prior to pouring concrete into the molding chamber.

In embodiments of the invention, the concrete reinforcing product can be selected from rebar, fiber reinforced polymer, carbon fibers, aramid fibers, glass fibers, metal fibers and combinations thereof.

As used herein, the term “fiber reinforced polymer” refers to plastics that include, but are not limited to reinforced thermoplastics and reinforced thermoset resins. Thermoplastics include polymers and polymers made up of materials that can be repeatedly softened by heating and hardened again on cooling. Suitable thermoplastic polymers include, but are not limited to homopolymers and copolymers of styrene, homopolymers and copolymers of C₂ to C₂₀ olefins, C₄ to C₂₀ dienes, polyesters, polyamides, homopolymers and copolymers of C₂ to C₂₀ (meth)acrylate esters, polyetherimides, polycarbonates, polyphenylethers, polyvinylchlorides, polyurethanes, and combinations thereof.

Suitable thermoset resins are resins that when heated to their cure point, undergo a chemical cross-linking reaction causing them to solidify and hold their shape rigidly, even at elevated temperatures. Suitable thermoset resins include, but are not limited to alkyd resins, epoxy resins, diallyl phthalate resins, melamine resins, phenolic resins, polyester resins, urethane resins, and urea, which can be crosslinked by reaction, as non-limiting examples, with diols, triols, polyols, and/or formaldehyde.

Fiber reinforcing materials that can be incorporated into the thermoplastics and/or thermoset resins include, but are not limited to carbon fibers, aramid fibers, glass fibers, metal fibers, woven fabric or structures of the mentioned fibers, and/or fiberglass, and can optionally include one or more fillers, non-limiting examples including carbon black, graphite, clays, calcium carbonate, titanium dioxide, and combinations thereof.

In an embodiment of the invention shown in FIG. 6, rebar can be added to the concrete wall and wall forming system. As such, reinforced insulated concrete wall 60 includes horizontal rebar 65, which can be placed through pour holes 36 and vertical rebar 70, which can be placed in molding chamber 50. At intersection 75, where horizontal rebar 65 and vertical rebar 70 intersect, the rebar can be secured into position using appropriate ties, rope, wire, etc. as is known in the art. In many embodiments of the invention, horizontal rebar 65 is placed at approximately the center of the cross-section of pour hole 36 and vertical rebar 70 is placed at approximately half way in between connecting members 16 and half way in between panels 12 and 14.

The present invention has been described with reference to specific details of particular embodiments thereof. It is not intended that such details be regarded as limitations upon the scope of the invention except insofar as and to the extent that they are included in the accompanying claims.

We claim:

1. A concrete wall forming system comprising
a plurality of mold units for forming a wall by receiving concrete therein, the units comprising:
(A) a first panel member comprising:
(1) a first outer panel side including a first wall surface area extending generally vertically thereon;
(2) a first inner panel side positioned oppositely from said first outer panel side; and
(3) at least two first slots in the first inner panel side extending vertically therethrough;
(B) a second panel member comprising:
(1) a second outer panel side including a second wall surface area extending generally vertically thereon and facing oppositely from said first panel member;
(2) a second inner panel side positioned oppositely from said second outer panel side and facing said first inner panel side of said first panel member; and
(3) at least two second slots in the second inner panel side extending vertically therethrough; and
(C) at least two connecting members detachable and securable with respect to said first panel member and said second panel member and extending the length vertically therebetween to maintain a spatial distance therebetween for defining a molding chamber therebetween, the connecting members comprising:
(1) a first flange detachably and securably extending within said first slot of said first panel member;
(2) a second flange detachably and securably extending within said second slot of said second panel member; and
(3) a mid-section portion comprising a plurality of pour holes spaced along its length vertically;
wherein the first panel member and the second panel member have a horizontal length of from about three feet to about thirty feet and a vertical height of from about three feet to about twenty feet; and

2. The concrete wall forming system according to claim 1, wherein the first panel member and the second panel member comprise an expanded polymer matrix.

3. The concrete wall forming system according to claim 2, wherein the expanded polymer matrix comprises one or more polymers selected from the group consisting of homopolymers of vinyl aromatic monomers; copolymers of at least one vinyl aromatic monomer with one or more of divinylbenzene, conjugated dienes, alkyl methacrylates, alkyl acrylates, acrylonitrile, and/or maleic anhydride; polyolefins; polycarbonates; and combinations thereof.

4. The concrete wall forming system according to claim 2, wherein the polymer matrix comprises an interpolymer of a polyolefin and in situ polymerized vinyl aromatic monomers.

5. The concrete wall forming system according to claim 2, wherein the polymer matrix comprises carbon black, graphite or a combination thereof.

6. The concrete wall forming system according to claim 1, wherein the first panel member and the second panel member each have a male end comprising a tongue edge and a female end comprising a female groove edge that facilitates a tongue and groove union between a corresponding members.

7. The concrete wall forming system according to claim 1, wherein a finish surface is attached to one or more of the first outer panel side and/or the second outer panel side.

8. The concrete wall forming system according to claim 2, wherein the finish surface is selected from the group consisting of wood, rigid plastics, wood paneling, concrete panels, cement panels, drywall, sheetrock, particle board, rigid plastic panels, a metal lath, and combinations thereof.

9. The concrete wall forming system according to claim 1, wherein the first slot and the second slot have a T-shaped cross-sectional shape.

10. The composite building panel according to claim 1, wherein the connecting member comprises a material selected from the group consisting of metal, construction grade plastics, composite materials, ceramics, and the like.

11. The concrete wall forming system according to claim 1, wherein the pour holes have a shape selected from the group consisting of round, oval, elliptical, square, rectangular, triangular, hexagonal and octagonal.

12. The concrete wall forming system according to claim 1, comprising a plurality of mold units arranged sequentially from a first unit to a last unit.

13. The concrete wall forming system according to claim 1, wherein the first panel units and the second panel units have a length of from 6 to 30 feet and a height of from 4 to 20 feet.

14. A wall comprising the concrete wall forming system according to claim 1, wherein concrete has been poured into and set in the molding chamber.

15. A continuous wall comprising the concrete wall forming system according to claim 12, wherein concrete has been poured into and set in the molding chambers.

16. The wall according to claim 14, wherein the concrete comprises one or more cements selected from the group consisting of Portland cements, pozzolana cements, gypsum cements, aluminous cements, magnesia cements, silica cements, and slag cements.

17. The wall according to claim 14, wherein the concrete is light-weight concrete.

18. The wall according to claim 17, wherein the lightweight concrete comprises from 10 to 90 volume percent of a cement composition, from 10 to 90 volume percent of particles having an average particle diameter of from 0.2 mm to 8 mm, a bulk density of from 0.028 g/cc to 0.64 g/cc, an aspect ratio of from 1 to 3, and from 10 to 50 volume percent of sand and/or other fine, wherein at least a portion of the sand and/or fine aggregate has a fineness modulus of less than 2; wherein the sum of components used does not exceed 100 volume percent.

19. The wall according to claim 14, wherein rebar is placed in the molding chamber prior to pouring concrete into the mold unit.
